(19) United States
(12) Patent Application Publication
(10) Pub. No.: US 2022/0311305 A1
(43) Pub. Date: Sep. 29, 2022

(54) ELECTRICAL MACHINE COMPRISING A HIGH-VOLTAGE CONNECTION ARRANGEMENT AND A SAFETY LOCKING DEVICE

(71) Applicant: ZF FRIEDRICHSHAFEN AG, Friedrichshafen (DE)

(72) Inventors: Sebastian BAUMGART, Burkardroth (DE); Katja WILLACKER, Wiesentheid (DE); Norbert LOHAUS, Schweinfurt (DE)

(21) Appl. No.: 17/638,915

(22) PCT Filed: Aug. 24, 2020
(86) PCT No.: PCT/EP2020/073628

§ 371 Date: Feb. 28, 2022

(30) Foreign Application Priority Data
Aug. 29, 2019 (DE) 10 2019 212 980.3

(51) Int. Cl. H02K 5/22; H01R 31/08

(52) U.S. Cl. CPC H02K 5/225; H01R 31/08; H02K 2213/06; H01R 24/20

(57) ABSTRACT

An electrical machine having a housing with a central receiving space in which a stator winding and an interconnection arrangement with a plurality of internal conductors is arranged. A high-voltage connection arrangement with a plurality of connecting points at which the internal conductors are connected in pairs to external conductors of a high-voltage source are provided. The high-voltage connection arrangement has a removable cover which closes an access region, and an electrical safety locking device (interlock) with a low-voltage circuit that detects an opening state of the access region of the high-voltage connection arrangement and the high-voltage connection arrangement is switched to zero potential when an open state of the access region is detected. The external conductors are inserted into the receiving space through the machine housing from the outside forming the high-voltage connection arrangement and arranging the electrical component within the receiving space.

### CROSS REFERENCE TO RELATED APPLICATIONS

This is a U.S. national stage of Application No. PCT/EP2020/073628 filed Aug. 24, 2020. Priority is claimed on German Application No. DE 10 2019 212 980.3 filed Aug. 29, 2019 the content of which is incorporated herein by reference.

### BACKGROUND OF THE INVENTION

### 1. Field of the Invention

The disclosure relates to an electrical machine having a high-voltage connection arrangement and a safety locking device.

### 2. Description of Related Art

An electrical machine is known from DE 10 2009 047 961 A1.

### SUMMARY OF THE INVENTION

A high-voltage connection arrangement is provided on a housing outer side of a motor-generator arrangement and comprises a control box in which three power supply cables are inserted and connected therein to connection conductors of the electrical machine by screw connections. Arranged adjacent thereto is a switch element, formed as a plug-in contact, of the safety locking device, which switch element comprises a conductor bridge provided in a removable cover of the control box. Upon removing the cover, the plug contact is therefore opened, whereby the high-voltage connection arrangement is de-energized by the safety locking device.

An object of one aspect of the invention is to improve an electrical machine of the type mentioned at the outset, whilst in particular reducing installation space and costs.

A generic electrical machine is therefore proposed, which has a machine housing having a central receiving space. A stator having a stator winding is arranged in the receiving space. An interconnection arrangement having a plurality of internal conductors is provided at the end face of the stator, which conductors are connected to the stator winding. The electrical machine further comprises a high-voltage connection arrangement having a plurality of connecting points at which the internal conductors are connected in pairs to external conductors which can be connected or are connected to a high-voltage source. The high-voltage connection arrangement furthermore has a removable guard, which closes an access region of the high-voltage connection arrangement. The electrical machine further comprises an electrical safety locking device (interlock) having a low-voltage circuit, wherein, as a result of a change in the assembly state of the guard, an electrical component is influenced to thus detect an opening state of the access region of the high-voltage connection arrangement. The high-voltage connection arrangement is de-energized upon a detected open state of the access region.

According to one aspect of the present invention, in the case of the electrical machine the external conductors are inserted into the central receiving space from the outside through the machine housing and that the high-voltage connection arrangement and the access region are formed within this receiving space and that the electrical component is further arranged within the receiving space.

As a result of the proposed design, it is therefore possible to dispense with a separate connection housing or an outer or inner housing portion of the machine housing that is formed separately from the central receiving space. The electrical machine can therefore be created in a space-saving and more cost-effective manner.

According to one aspect of the present invention, the access region can be formed at the end face of the machine housing and outside the axial extent of a stator laminated core. An outer diameter of the machine housing can simply be dimensioned according to a stator and/or rotor diameter. Owing to the interconnection device, which is conventionally provided at the end face of the stator, a sufficiently large installation space is already provided for many applications in this region and can be expanded in the axial direction if required.

According to one aspect of the present invention, the guard can be provided at an end shield of the machine housing so that it is possible to reach into the access region axially with respect to the machine axis and insert a tool in this direction.

According to one aspect of the present invention, the internal conductors can be arranged substantially in a common connecting plane, wherein the external conductors are also inserted into the receiving space through the machine housing, and connected to the internal conductors at the connecting points, substantially in this connecting plane. The external conductors can be formed in particular as flat strip-shaped connection conductors and can thus reach finger-like into the machine housing through a comparatively narrow opening. To this end, the opening can preferably be provided on an outer circumferential surface of a cylindrical housing portion. The external conductors can preferably reach into the receiving space in a plane, which is perpendicular to the machine axis. The connecting plane can be a plane parallel to the end shield, for example.

The electrical component can particularly advantageously be formed as a coupling having two coupling elements, which are joined to one another in an opening direction of the guard and wherein one of the coupling elements is fastened on the guard and the other coupling element is fastened on the interconnection arrangement. The coupling can have at least two connection poles and be formed in particular as a plug-in coupling. In particular, the coupling can have a first coupling element formed as a socket with two open contacts, wherein the contacts can be electrically bridged or connected by a conductor bridge of a second coupling element formed as a plug. In this case, the joining direction of the coupling elements coincides with the opening direction of the guard. The joining direction can further be somewhat perpendicular to the connecting plane of the internal and external conductors.

One of the coupling elements can further advantageously be fastened such that it is capable of a limited lateral displacement in a plane which is substantially perpendicular to the opening direction of the guard or the joining direction of the coupling elements by utilizing a movement clearance. As a result, when seating the guard and simultaneously joining the coupling elements together, a compensation of manufacturing and assembly tolerances can take place and a secure connection of the coupling elements can thus be generated.

At least one of the coupling elements can even further advantageously be formed in two parts and have a base part, which can be fastened on the interconnection arrangement or on the guard, and an electrical contact part which can be connected to said base part. The base part and the contact part can further be connected to one another without tools, which can take place for example by a plug-in latching connection.

A receiving portion for receiving the base part can preferably be formed on the interconnection arrangement or on the guard, wherein the lateral movement clearance is formed between the receiving portion and the base part.

To achieve an installation-space-saving arrangement, the electrical component can be arranged between two connecting points on the high-voltage connection arrangement. In particular if the electrical component is formed as a coupling having two coupling elements, one of the coupling parts can be fastened between two connecting points or between two internal conductors on the interconnection arrangement.

One aspect of the invention is an electrical machine according to a previously described configuration, which further comprises a rotor which is mounted to be rotatable about an axis A for cooperation with the stator.

### BRIEF DESCRIPTION OF THE DRAWINGS

The invention is explained by way of example below, with reference to an embodiment illustrated in the figures, in which:

FIG. 1 is a schematic illustration of an electrical machine with a high-voltage connection arrangement and a safety locking device;

FIG. 2 is a perspective illustration of the high-voltage connection arrangement of an electrical machine when the machine housing is opened with a first coupling element of the safety locking device;

FIG. 3 is an end-face plan view of the high-voltage connection arrangement when the guard of an access region is removed;

FIG. 4 is a perspective view of the interconnection arrangement of the electrical machine with the first coupling element, shown in FIG. 2, of the safety locking device;

FIG. 5 is a sectional illustration of the high-voltage connection arrangement with a separable two-part coupling of the safety locking device;

FIG. 6 is a perspective view of the first coupling element, shown in FIG. 2, of the safety locking device; and

FIG. 7 shows a cover element for closing the access region of the high-voltage connection arrangement.

### DETAILED DESCRIPTION OF THE PRESENTLY PREFERRED EMBODIMENTS

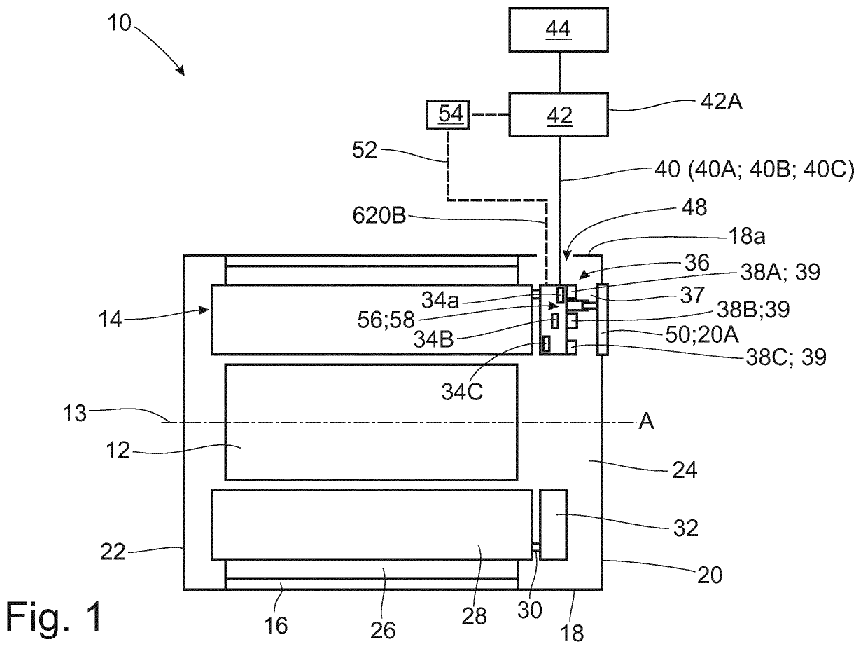

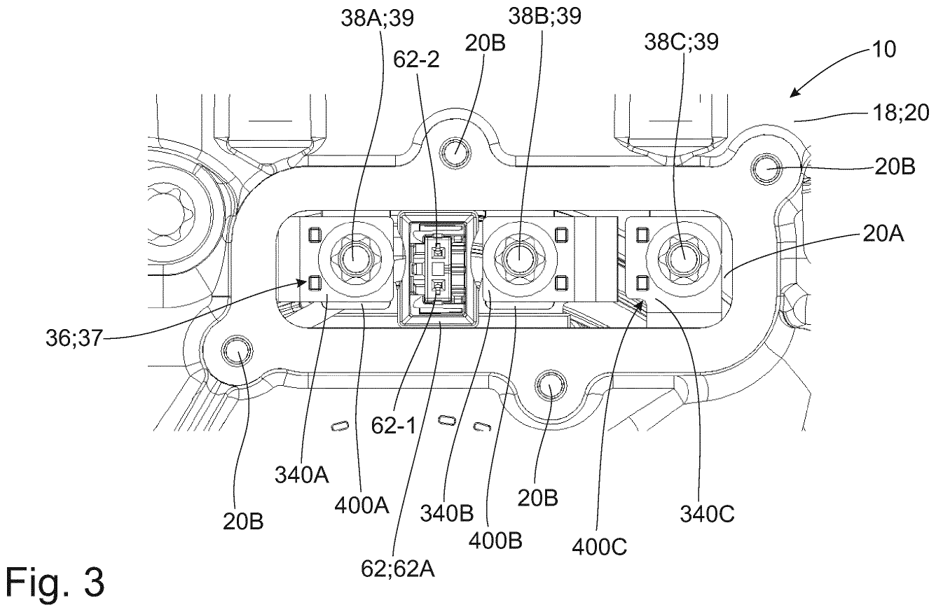

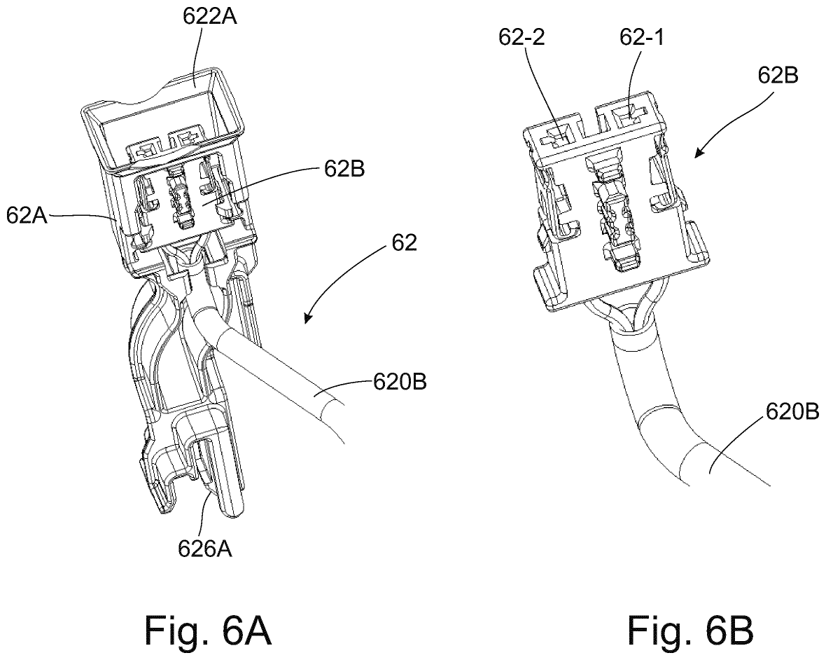

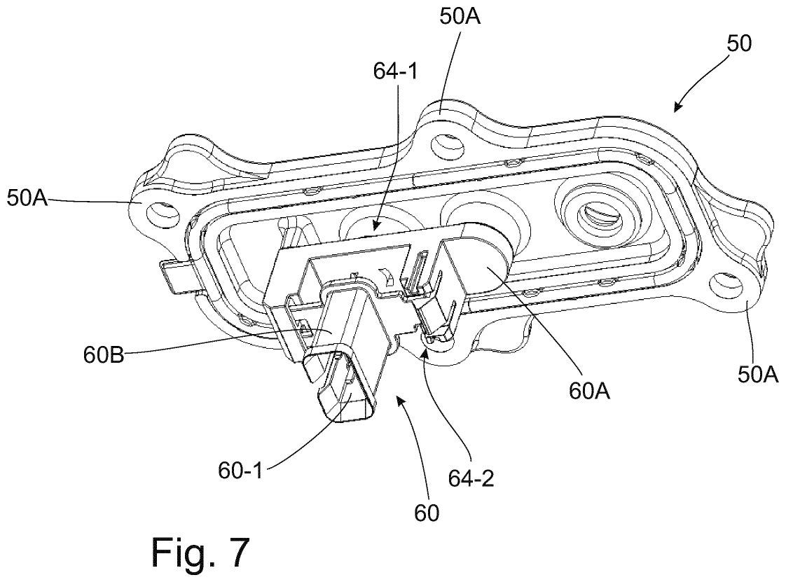

When seen together, FIGS. 1-7 are based on a single, coherently explained exemplary embodiment, wherein individual reference signs may only be incorporated in respective detailed views.

FIG. 1 shows a schematic view of an electrical machine 10, which is provided as an electrical drive in a drive train of an electric or hybrid vehicle and can be installed for example as an axle drive in or on a drive axle or between an internal combustion engine and a gear or in another position. The electrical machine 10 comprises a rotor 12, which is mounted to be rotatable about an axis A, and a stator 14 surrounding this rotor coaxially. The stator 14 is fastened with a stator carrier 16 on a substantially cylindrical machine housing 18, which is delimited at the end face by end shields 20, 22 for mounting the rotor 12 by a rotor shaft 13. The machine housing 18 therefore forms a central receiving space 24 for the stator 14 and the rotor 12.

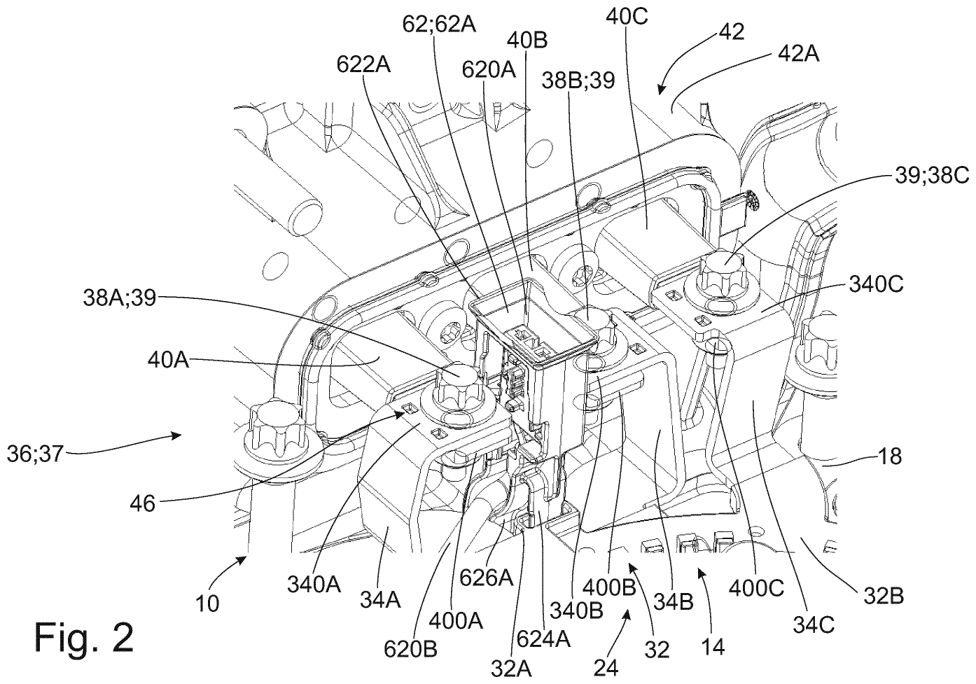

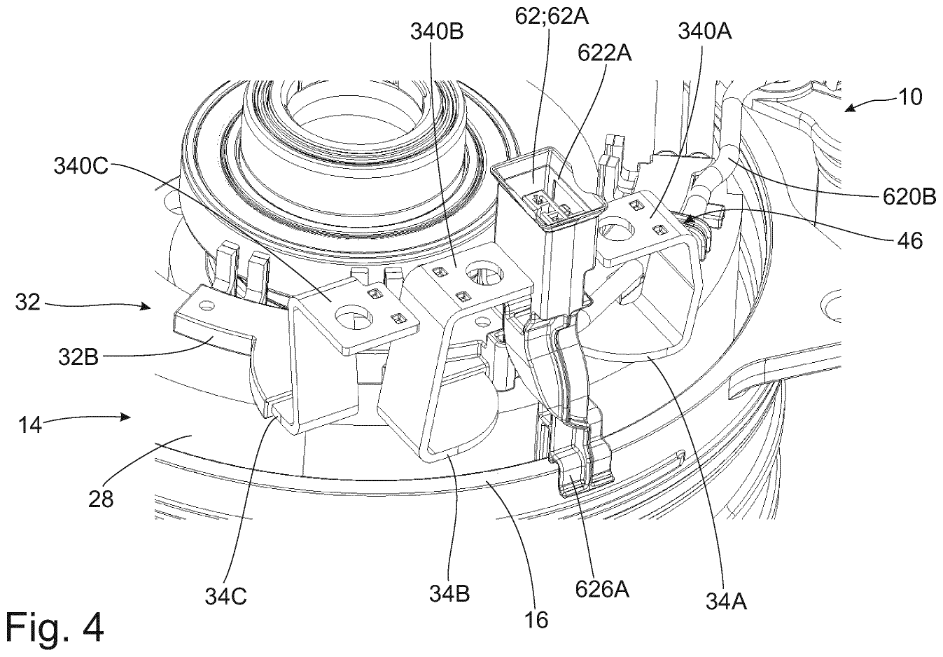

The stator 14 comprises a stator laminated core 26 on which a multi-phase stator winding 28 is formed to generate an electromagnetic alternating field and wherein winding ends 30 are connected to a plurality of strip-shaped collector bars 34 or busbars 34 (34A, 34B, 34C) by an interconnection arrangement in the interior of the electrical device. The collector bars 34 form internal conductors and extend in the circumferential direction at the end face of the stator 14 and can surround this completely or partially and, in the latter case, be formed as ring segments. The busbars 34 are insulated from one another and, in the exemplary embodiment, are overmolded with a plastic apart from the exposed connection portions 340 (340A, 340B, 340C) visible for example in FIGS. 2 and 4, whereby the interconnection arrangement 32 is provided as a prefabricated plastic-metal composite element.

The electrical machine 10 further comprises a high-voltage connection arrangement 36 having a plurality of connecting points 38 (38A, 38B, 38C) at which the internal conductors in the form of the busbars 34 are connected in pairs by the tab-shaped connection portions 340 to external conductors 40 (40A, 40B, 40C) by threaded bolts 39, which can be connected to a high-voltage source 44 via an inverter 42. The inverter 42 is arranged in an inverter housing 42A, which is arranged and formed separately from the machine housing 18 in the schematic illustration of FIG. 1 and directly adjacent to and on the machine housing 18 in FIG. 2. The machine housing 18 can be provided in one part with a cylindrical main part and the inverter housing 42A and produced as an aluminum cast part. For this purpose, the connection portions 340 of the internal conductors are arranged substantially within a common connection plane 46 and as a linear arrangement. It can be seen that the connection portions 340 are arranged at an axial spacing with respect to a base region 32B, molded from plastic, of the interconnection arrangement 32 so that the threaded bolts 39 penetrating into the spacing region formed thereby have sufficient space for the screw connection.

The external conductors 40 in FIG. 2 have connection portions 400 (400a, 400b, 400c), which are inserted into the receiving space 24 from the outside through one or more feedthrough openings 48 leading into the machine housing 18, and connected in each case to the internal conductors 34 by a screw connection at the connecting points 38, substantially in this above-mentioned connecting plane 46. To this end, the feedthrough opening 48 is provided on the circumferential surface of the housing portion 18a which is formed with a planar surface in this region.

As can be seen in FIGS. 2, 3 and 5, the external conductors 40 in the illustrated detail are formed as flat strip-shaped connection conductors and are likewise arranged such that their connection portions 400 are linear in the connecting plane 46 so that the connection portions of the internal conductors 34 and the external conductors 40 can overlap one another in pairs to establish the screw connection.

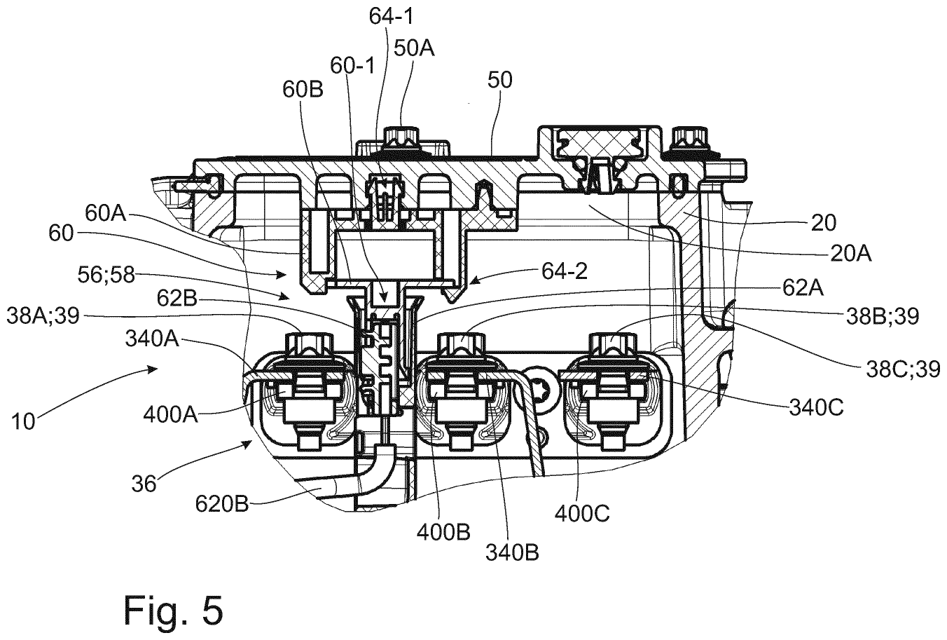

The high-voltage connection arrangement 36 has a removable guard or a cover 50 (FIG. 5, 7) at the end shield 20 (FIG. 1) for exposing an opening 20A in the end shield 20, which forms a plurality of openings 50a in the edge region for inserting threaded bolts and wherein the threaded bolts can be inserted into threaded bores 20B, formed for this purpose, on the machine housing 18 or on the end shield 20 and therefore securely close an access region 37 of the high-voltage connection arrangement 36. The guard 50 can be opened to establish or break the connection of the internal and external conductors 34; 40 or, for example, for inspection purposes. The access region 37 is formed at the end face of the machine housing 18 and outside the axial extent of the stator laminated core 26. It is possible to reach into the access region 37 axially with respect to the machine axis A and to insert a tool in this direction.

The electrical machine 10 further comprises an electrical safety locking device (interlock) 52 having a low-voltage circuit 54 (illustrated merely schematically in the drawing in FIG. 1). The safety locking device 52, as a result of a change in the assembly state of the guard 50, causes an electrical component 56 of the low-voltage circuit 54 located in the access region 37 to be firstly influenced to thus detect an opening state of the access region 37 of the high-voltage connection arrangement 36. If an open state of the access region 37 is detected, the high-voltage connection arrangement 36 is de-energized so that it is possible to reach into the high-voltage connection region of the electrical machine 10 without any danger. This means that the electrical machine 10 can only be operated if the guard 50 lies as specified on the housing 18 and it is not possible to inadvertently reach manually into the access region 37.

The high-voltage connection arrangement 36 and the access region 37 are formed within the receiving space 24 as can be seen in FIGS. 1, 2, 4 and 5.

The previously mentioned electrical component 56 is likewise arranged within the receiving space 24 and is located in a space-saving and at the same time protected manner between two connecting points 38 on the high-voltage connection arrangement 36 or between two connection portions 340 and 400 on the interconnection arrangement 32.

The component 56 of the safety locking device 52 is generally formed as an interrupter contact in the form of an electrical coupling 58 or a switch. The coupling 58 has two electrical connections or contacts and, in the present case, is formed as a plug-in coupling 58 having two coupling elements 60, 62, which can be joined together in an opening direction of the guard 50. To this end, the coupling element 60 is fastened on the guard 50 and the other coupling element 62 is fastened on the interconnection arrangement 32.

The coupling element 62, which is fastened between two internal conductors 34 or connection tabs 340 on the interconnection arrangement 32, is formed with two open socket-shaped contacts 62-1; 62-2, which can be electrically bridged or connected by a conductor bridge 60-1 of the coupling element 60 formed as a plug and fastened on the guard 50. The joining direction of the coupling elements 60, 62 coincides with the opening direction of the guard 50, wherein the joining direction is also approximately perpendicular to the connecting plane 46 of the internal and external conductors 34, 40.

The coupling element 60 is formed in two parts and has a base part 60A connected to the cover 50 by a latching connection 64-1 and a contact part 60B for the conductor bridge 60-1, which contact part is joined together with the base part by a latching connection 64-2 (FIG. 5, 7).

The coupling element 62 is likewise formed in two parts and has a base part 62A arranged on the interconnection arrangement 32 and an electrical contact part 62B for a signal line 620B, which contact part can be connected to the base part. The base part 62A and the contact part 62B are connected to one another without tools by a plug-in latching connection. The contact part 62B is further arranged in a protected manner within a receiving space 620A formed in the base part 62A and is incorporated within the base part 62A such that it is slightly recessed in the direction of the guard element 50. A collar 622A, which is formed in the assembly direction and opens to the cover 50 in the form of a funnel, projects over the contact part 62B so that the collar 622A can act as a mutual positioning aid when the two parts are plugged together.

To ensure mutual engagement of the two coupling elements 60; 62, the coupling element 62 arranged on the interconnection arrangement 32 is capable of a limited lateral displacement in the plane which is substantially perpendicular to the opening direction of the guard or the joining direction of the coupling elements 60, 62 by utilizing a movement clearance. As a result, if the guard 50 is seated on the housing 18, in particular on the end shield 20, and there is a deviation in the position of this coupling element 62, a lateral displacement of this coupling element 62 can take place until the two coupling elements 60, 62 can be joined together in a simple and trouble-free manner. For this purpose, a receiving portion 32A for receiving a first supporting portion 624A of the base part 62A is formed on a plastic region of the interconnection arrangement 32, wherein the lateral movement clearance between the receiving portion 32A and the base part 62A is adjusted or retained. Further fastening and axial support of the base part 62A takes place via a second supporting portion 626A, which is supported on the stator carrier 16 and which likewise has a lateral movement clearance there.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. An electrical machine, comprising:
a machine housing having a central receiving space;
a stator arranged in the central receiving space, having:
a stator winding and
an interconnection arrangement arranged at an end face of the stator, comprising:
a plurality of internal conductors;
a high-voltage connection arrangement having a plurality of connecting points at which the internal conductors are configured to be connected in pairs to external conductors connected to a high-voltage source;
a guard, which is removable, and which closes an access region of the high-voltage connection arrangement; and
an electrical safety locking device having a low-voltage circuit, wherein, as a result of a change in an assembly state of the guard, an electrical component is influenced to thus detect an opening state of the access region of the high-voltage connection arrangement, and wherein the high-voltage connection arrangement is de-energized upon a detected open state of the access region, wherein:
the external conductors are inserted into the central receiving space from the outside through the machine housing;
the high-voltage connection arrangement and the access region are formed within the central receiving space; and
the electrical component is arranged within the central receiving space.

12. The electrical machine as claimed in claim 11, wherein the access region is formed at an end face of the machine housing and outside an axial extent of a stator laminated core.

13. The electrical machine as claimed in claim 11, wherein the guard is provided at an end shield of the machine housing.

14. The electrical machine as claimed in claim 11, wherein the internal conductors are arranged in a substantially common connecting plane and in that the external conductors are inserted into the central receiving space through the machine housing, and connected to the internal conductors at the connecting points, substantially in this connecting plane.

15. The electrical machine as claimed in claim 11, wherein the electrical component is a coupling having two coupling elements that are joined to one another in an opening direction of the guard and wherein one of the coupling elements is fastened on the guard and an other coupling element is fastened on the interconnection arrangement.

16. The electrical machine as claimed in claim 15, wherein one of the coupling elements is fastened such that it is capable of a limited lateral displacement in a plane which is substantially perpendicular to the opening direction of the guard or a joining direction of the coupling elements by utilizing a movement clearance.

17. The electrical machine as claimed in claim 15, wherein one of the coupling elements is formed in two parts and has a base part fastened on the interconnection arrangement or on the guard, and an electrical contact part connected to the base part.

18. The electrical machine as claimed in claim 17, wherein the interconnection arrangement or the guard has a receiving portion for receiving the base part, between which receiving portion and the guard a lateral movement clearance is formed.

19. The electrical machine as claimed in claim 11, wherein the electrical component is fastened between two connecting points on the high-voltage connection arrangement.

20. The electrical machine as claimed in claim 11, wherein a rotor is mounted to be rotatable about an axis A is provided for cooperation with the stator.
